(19) United States
(12) Patent Application Publication
(10) Pub. No.: US 2024/0021040 A1
(43) Pub. Date: Jan. 18, 2024

(54) MEDIA HANDLING APPARATUS AND MANAGEMENT SYSTEM

(71) Applicant: Oki Electric Industry Co., Ltd., Tokyo (JP)

(72) Inventor: Atsushi TAKADA, Tokyo (JP)

(73) Assignee: Oki Electric Industry Co., Ltd., Tokyo (JP)

(21) Appl. No.: 18/253,059

(22) PCT Filed: Nov. 2, 2021
(86) PCT No.: PCT/JP2021/040453

§ 371 Date: May 16, 2023

(30) Foreign Application Priority Data
Nov. 27, 2020 (JP) 2020-196846

(51) Int. Cl. G07D 11/16; G07D 11/34; G07D 7/004; G06K 7/10

(52) U.S. Cl. CPC G07D 11/16; G07D 11/34; G07D 7/004; G06K 7/10366; G07D 2211/00; G07D 2207/00

(57) ABSTRACT

A media handling apparatus includes: an accumulation unit that accumulates plural sheets of media in a bundle; a strapping unit that straps a media bundle which is the plural sheets of media accumulated by the accumulation unit; and a storage compartment that is provided under the strapping unit and to which can be attached a storage bag that stores the media bundle strapped by the strapping unit.

### TECHNICAL FIELD

The present application claims priority to Japanese Patent Application No. 2020-196846, filed on Nov. 27, 2020, which is incorporated by reference herein in its entirety.

The present disclosure relates to a media handling apparatus and a management system.

### BACKGROUND ART

As a media handling apparatus, there is an automated transaction machine (ATM) installed in a backroom or the like of a store such as a convenience store or a supermarket, for example. The automated transaction machine is configured to conduct various types of transactions such as deposit transactions that allow a user (e.g., a store clerk) to deposit cash such as banknotes and coins (e.g., deposit sales proceeds) and withdrawal transactions that dispense cash (e.g., dispense change reserves) to the user.

Furthermore, the automated transaction machine includes a collection mechanism for collecting banknotes stored inside the machine. Conventionally, as the collection mechanism that such an automated transaction machine has, there is a type that drops and stores the banknotes in a storage bag that is detachable from the automated transaction machine (e.g., see International Publication (WO) No. 2019/244337).

FIG. 10 shows an example of such a collection mechanism. The collection mechanism shown in FIG. 10 has a temporary retention unit 300 that accumulates, in a bundle of a fixed number, banknotes that have been transported thereto, a storage bag 301 that is set under the temporary retention unit 300, and a stage 302 that moves in the vertical direction so as to compress the lower portion of the storage bag 301 and thereby displace the portion (i.e., the bottom portion) serving as the bottom of the storage bag 301. The storage bag 301 has a longitudinal and transverse size that is substantially the same as the longitudinal and transverse size of the banknotes, and the storage bag 301 is able to store the banknotes by stacking them on top of each other.

In this collection mechanism, the stage 302 is moved upward to bring the bottom portion of the storage bag 301 closer to the temporary retention unit 300, and thereafter the bundled banknotes (i.e., the banknote bundle) accumulated by the temporary retention unit 300 are dropped from the temporary retention unit 300 into the storage bag 301. At this time, the bottom portion of the storage bag 301 has been brought closer to the temporary retention unit 300 by the stage 302 and the longitudinal and transverse size of the storage bag 301 is substantially the same as the longitudinal and transverse size of the banknotes, so the banknotes are stored so as to lie on top of each other on the bottom portion. Thereafter, in this collection mechanism, the stage 302 is moved downward a little at a time and the banknote bundles are dropped into the storage bag 301, whereby the banknote bundles become stacked on top of each other and stored inside the storage bag 301.

### SUMMARY OF INVENTION

### Technical Problem

In the conventional collection mechanism, it takes time and effort to set the storage bag 301 because of the mechanism that compresses the lower portion of the storage bag 301 by means of the stage 302.

The present disclosure has been made in consideration of the above point and proposes a media handling apparatus and a management system configured so that the storage bag can be easily set.

### Solution to Problem

A first aspect of the disclosure is a media handling apparatus including: an accumulation unit that is configured to accumulate plural sheets of media in a bundle; a strapping unit that is configured to strap a media bundle which is the plural sheets of media accumulated by the accumulation unit; and a storage compartment that is disposed under the strapping unit and to which a storage bag that stores the media bundle strapped by the strapping unit is attached.

Furthermore, a second aspect of the disclosure is a management system including: the media handling apparatus of the first aspect; and a management device, wherein the media handling apparatus further includes: a first information acquisition unit that is configured to acquire, from the storage bag, first bag identification information for identifying the storage bag and first bundle identification information for identifying the media bundle stored in the storage bag and a transmission unit that is configured to transmit, to the management device, the first bag identification information and the first bundle identification information acquired by the first information acquisition unit, and the management device includes: a receiving unit that is configured to receive the first bag identification information and the first bundle identification information sent from the media handling apparatus, a storage unit that is configured to store the first bag identification information and the first bundle identification information received by the receiving unit, a second information acquisition unit that is configured to acquire second bag identification information for identifying the storage bag from the storage bag and second bundle identification information from a strapping member strapping the media bundle stored in the storage bag, and a determination unit that is configured to determine whether or not the first bag identification information and the second bag identification information and whether or not the first bundle identification information and the second bundle identification information respectively match.

In this way, in the present disclosure, the storage bag may be easily set because the media handling apparatus does not have a mechanism that compresses the lower portion of the storage bag by means of a stage.

### Effects of Invention

According to the present disclosure, a media handling apparatus and a management system configured in which a storage bag is able to be be easily set may be realized.

### BRIEF DESCRIPTION OF DRAWINGS

FIG. 1 is a perspective view showing an external configuration of an automated transaction machine according to a first embodiment.

FIG. 2 is a side sectional view showing a configuration of a banknote depositing and dispensing machine according to the first embodiment.

FIG. 3A is a side sectional view showing a configuration of an upper unit of the banknote depositing and dispensing machine according to the first embodiment.

FIG. 3B is a side sectional view showing a configuration of a lower unit of the banknote depositing and dispensing machine according to the first embodiment.

FIG. 4 is a block diagram showing a configuration of a banknote control unit according to the first embodiment.

FIG. 5 is a perspective view showing a banknote bundle strapped with a clip according to the first embodiment.

FIG. 6 is a side sectional view showing a configuration of an accumulating and strapping unit according to the first embodiment.

FIG. 7 is a drawing showing a configuration of storage information according to the first embodiment.

FIG. 8 is a diagram showing a system configuration of a management system according to a second embodiment.

FIG. 9 is a drawing showing a configuration of collection information according to the second embodiment.

FIG. 10 is a side sectional view showing a configuration of a conventional collection mechanism.

### DESCRIPTION OF EMBODIMENTS

Modes (hereinafter, embodiments) for implementing the disclosure will be described below using the drawings.

### 1. First Embodiment

### 1-1. Overall Configuration of Automated Transaction Machine

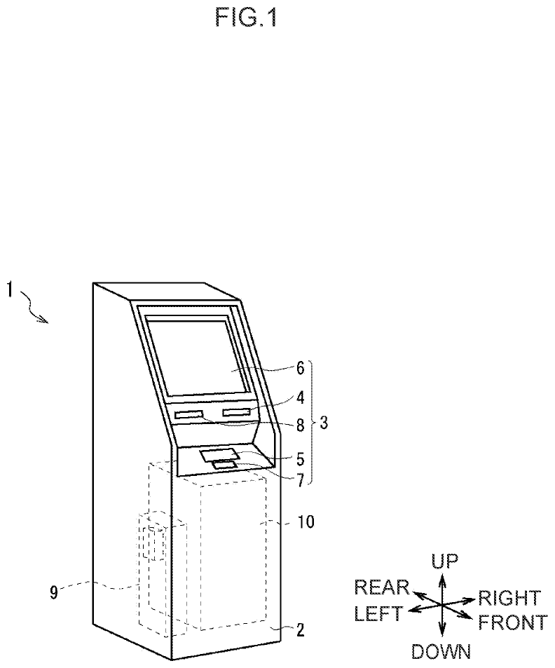

First, a first embodiment of the disclosure will be described. FIG. 1 shows the exterior of an automated transaction machine 1 serving as a media handling apparatus. The automated transaction machine 1 is a machine installed in a backroom or the like of a store such as a convenience store or a supermarket, for example, and conducts transactions relating to cash, such as deposit processes and withdrawal processes, with a user (e.g., a store clerk). Here, the front side facing the user will be defined as the front side of the automated transaction machine 1, the opposite side will be defined as the rear side of the automated transaction machine 1, and the upper side, the lower side, the left side, and the right side as viewed from the standpoint of the user facing the front side of the automated transaction machine 1 will be defined as the upper side, the lower side, the left side, and the right side, respectively, of the automated transaction machine 1.

The automated transaction machine 1 has an exterior formed by a substantially box-shaped housing 2. The housing 2 is provided with a reception unit 3 in a place where it is easy for the user facing the front side thereof to input banknotes and perform operations using a touch panel.

The reception unit 3 is provided with a card insertion/ejection slot 4, a cash input/dispense opening 5, an operation/display unit 6, a numerical keypad 7, and a receipt issuing slot 8, directly exchanges cash and such with the user, notifies the user of transaction-related information, and accepts operation instructions. The card insertion/ejection slot 4 is a portion into which various types of cards such as cash cards are inserted or from which they are ejected. On the far side of the card insertion/ejection slot 4 is provided a card processing unit that reads individual management numbers and such for identifying users magnetically recorded in the various types of cards. The cash input/dispense opening 5 is a portion to which banknotes deposited by the user are input and from which banknotes to be withdrawn are dispensed to the user. Furthermore, the cash input/dispense opening 5 is opened or closed by the driving of a shutter.

The operation/display unit 6 is a touch panel in which a liquid crystal display panel that displays operation screens and transaction details during transactions and a touch sensor that detects input operations by the user are integrated. The numerical keypad 7 includes physical keys that accept input of the numbers “0” to “9”, for example, and is used during operations to input personal identification numbers and transaction amounts. The receipt issuing slot 8 is a portion that issues receipts on which transaction details and such are printed at the end of a transaction process. On the far side of the receipt issuing slot 8 is provided a receipt processing unit that prints transaction details and such on the receipts.

Inside the housing 2 are provided a main control unit 9 that centrally controls the entire automated transaction machine 1 and a banknote depositing and dispensing machine 10 that performs various types of processes relating to banknotes. The main control unit 9 is configured around a central processing unit (CPU) and performs various types of processes such as deposit processes and withdrawal processes by reading and executing a predetermined program from a read-only memory (ROM) or flash memory. Furthermore, the main control unit 9 has a storage unit including a random access memory (RAM), a hard disk drive, and/or flash memory inside and stores various types of information in the storage unit.

### 1-2. Configuration of Banknote Depositing and Dispensing Machine

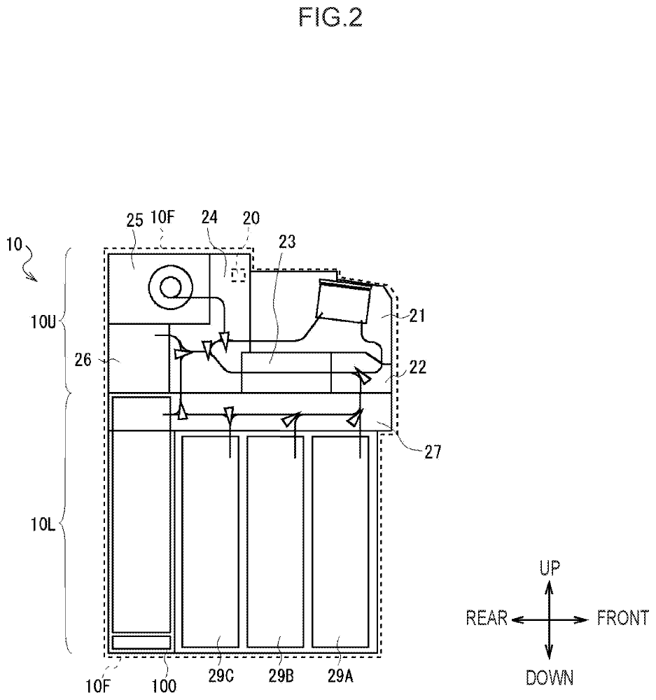

Next, the internal configuration of the banknote depositing and dispensing machine 10 will be described using FIG. 2. FIG. 2 is a side sectional view of the banknote depositing and dispensing machine 10. The banknote depositing and dispensing machine 10 is broadly configured by an upper unit 10U that occupies the upper portion of the whole, a lower unit 10L that occupies the lower portion of the whole, and a frame 10F that forms an outer frame portion of the whole and holds the upper unit 10U and the lower unit 10L.

The frame 10F is attached to the inside of the housing 2 (FIG. 1). The frame 10F holds each of the upper unit 10U and the lower unit 10L via slide rails that extend in the front and rear direction. For this reason, the banknote depositing and dispensing machine 10 is configured so that, in a state in which a front door (or a rear door) of the housing 2 is open, the upper unit 10U and the lower unit 10L is each able to be pulled out forward (or rearward) from the frame 10F and, furthermore, the upper unit 10U and the lower unit 10L that have been pulled out is each able to be pushed into the frame 10F and stored inside the frame 10F.

### 1-2-1. Configuration of Upper Unit

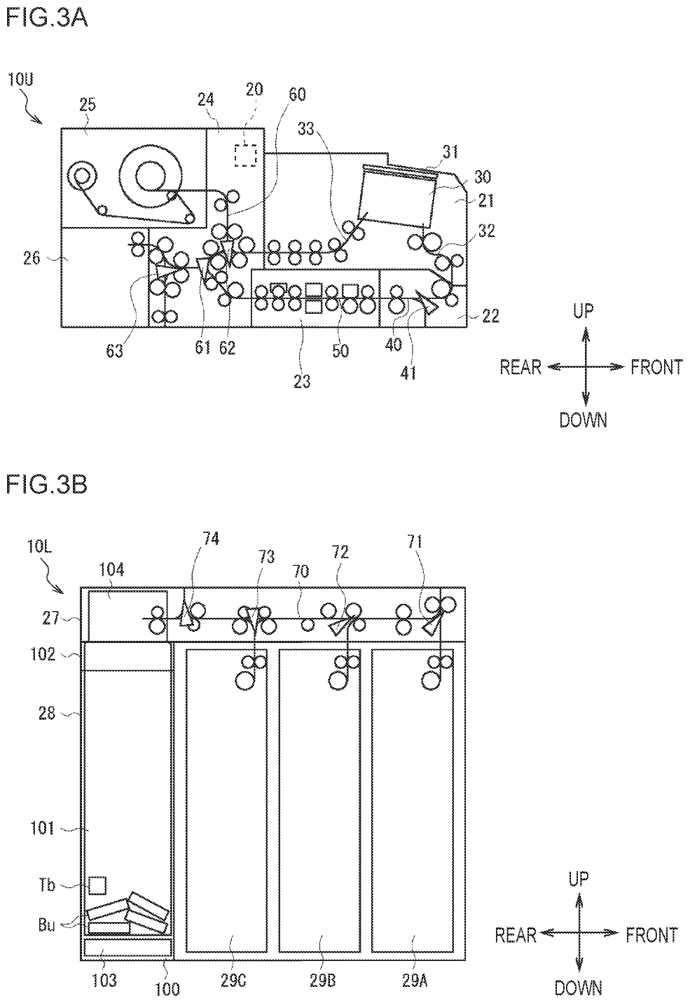

As shown in FIG. 3A, which is an enlargement of the upper portion of FIG. 2, in the upper unit 10U are provided a banknote control unit 20 that centrally controls the whole, a customer service unit 21, an upper front transport unit 22, a classification unit 23, an upper rear transport unit 24, a temporary retention unit 25, and a reject bin 26.

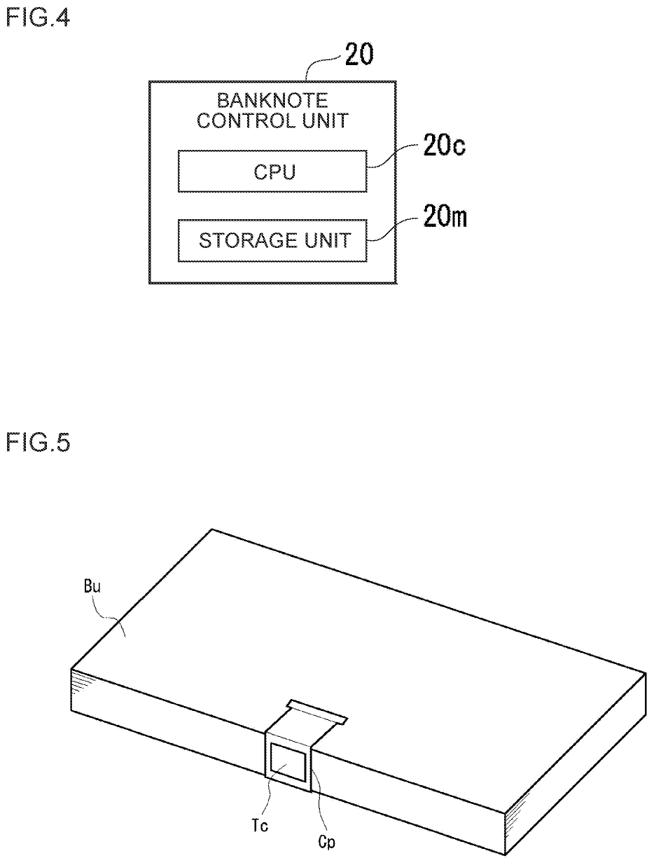

The banknote control unit 20 is configured around a CPU 20c as shown in FIG. 4 and performs various types of processes, such as processes to determine the transport destination of the banknotes and processes to control the operation of each part, by reading and executing a predetermined program from a ROM or flash memory. Furthermore, the banknote control unit 20 has a storage unit 20m including a RAM and/or flash memory inside and stores various types of information in the storage unit 20m. The position of the banknote control unit 20 shown in FIG. 3A is an example, and the banknote control unit 20 may be provided in another position.

The customer service unit 21 is a section which, by accepting banknotes from and delivering banknotes to the user, allows the user to deposit banknotes and allows the user to withdraw banknotes. The customer service unit 21 has a container 30 that contains the banknotes. The upper end of the container 30 is an opening connected to the cash input/dispense opening 5 (FIG. 1). The customer service unit 21 is configured so that the opening of the container 30 is opened or closed by a movable shutter 31. Furthermore, the customer service unit 21 has a transport path 32, which interconnects the front end portion of the container 30 and the upper front transport unit 22 positioned under the front side of the customer service unit 21, and a transport path 33, which interconnects the rear end portion of the container 30 and the upper rear transport unit 24 positioned in back of the customer service unit 21.

The customer service unit 21 separates one at a time the banknotes contained in the container 30 and transports, by means of transport rollers indicated by circles in the drawings, the banknotes along the transport path 32 to the upper front transport unit 22. Furthermore, the customer service unit 21 transports, by means of transport rollers along the transport path 33 to the container 30, banknotes that have been transported thereto from the upper rear transport unit 24 and releases the banknotes into the container 30.

The upper front transport unit 22 is positioned in the front lower portion of the inside of the upper unit 10U, and has a transport path 40 with one fork and a switcher 41 that is provided in the fork of the transport path 40 and switches the banknote transport pathway. The transport path 40 is connected to the transport path 32 of the customer service unit 21, the classification unit 23, and the front portion of the lower unit 10L.

The upper front transport unit 22, as a result of the switcher 41 being operated in accordance with the control of the banknote control unit 20, switches the banknote transport pathway formed using the transport path 40 to a transport pathway interconnecting the transport path 32 of the customer service unit 21 and the classification unit 23 or a transport pathway interconnecting the classification unit 23 and the front portion of the lower unit 10L. Additionally, the upper front transport unit 22 is configured to transport the banknotes by means of transport rollers along the switched transport pathway.

The classification unit 23 is positioned under the customer service unit 21 and in back of the upper front transport unit 22. The classification unit 23 has a linear transport path 50 connected to the upper front transport unit 22 in front and the upper rear transport unit 24 in back, and plural sensors are disposed along the transport path 50. The classification unit 23 is configured to transport the banknotes by means of transport rollers along the transport path 50, judge the denominations, authenticity, fitness (whether or not there is damage), and transport state of the banknotes as well as read the serial numbers of the banknotes based on detection results obtained from the plural sensors, and send these information as classification results to the banknote control unit 20.

The upper rear transport unit 24 is positioned in back of the customer service unit 21 and the classification unit 23. The upper rear transport unit 24 has a transport path 60 with three forks and switchers 61, 62, 63 respectively provided in the three forks.

The transport path 60 is connected to the transport path 33 of the customer service unit 21, the classification unit 23, the temporary retention unit 25, the reject bin 26, and the rear portion of the lower unit 10L. The upper rear transport unit 24 is, as a result of the three switches 61, 62, 63 being operated in accordance with the control of the banknote control unit 20, configured to switch the banknote transport pathway formed using the transport path 60 to a transport pathway interconnecting the classification unit 23 and the temporary retention unit 25, a transport pathway interconnecting the classification unit 23 and the transport path 33 of the customer service unit 21, a transport pathway interconnecting the classification unit 23 and the reject bin 26, or a transport pathway interconnecting the rear portion of the lower unit 10L and the reject bin 26. Additionally, the upper rear transport unit 24 is configured to transport the banknotes by means of transport rollers along the switched transport pathway.

The temporary retention unit 25 is, for example, a tape type retention unit and wraps and stores, on a peripheral side surface of a drum together with tape, banknotes that have been transported thereto from the upper rear transport unit 24. Furthermore, the temporary retention unit 25, when paying out the banknotes, is configured to pull away the banknotes together with the tape from the peripheral side surface of the drum and deliver them to the upper rear transport unit 24.

The reject bin 26 is a portion that stores reject banknotes judged to be notes that should not be dispensed due to a large extent of damage, for example, and when reject banknotes are transported thereto from the upper rear transport unit 24, the reject banknotes are released to a storage space inside the reject bin 26 and stored therein.

### 1-2-2. Configuration of Lower Unit

As shown in FIG. 3B, which is an enlargement of the lower portion of FIG. 2, in the upper end portion of the lower unit 10L is disposed a lower transport unit 27, and under the lower transport unit 27 is provided a lower frame 28. The lower frame 28 is in the shape of a hollow cuboid whose upper end is open, and inside, three banknote storage bins 29 (29A, 29B, 29C) that store reusable (recyclable) banknotes are disposed in a line in the front and rear direction, with a banknote collection bin 100 (also referred to as a storage compartment) that stores banknotes collected from the automated transaction machine 1 being disposed further in back of the rearmost banknote storage bin 29C.

The banknote storage bins 29 (29A to 29C) are all configured similarly, with each being in the shape of a cuboid that is long in the up and down direction. Each banknote storage bin 29 may store and pay out banknotes, and when storing banknotes, each banknote storage bin 29 releases to a storage space inside and accumulates banknotes that have been transported thereto by the lower transport unit 27. Furthermore, when paying out banknotes, each banknote storage bin 29 is configured to separate one at a time from the top the banknotes accumulated in the storage space inside, transport them upward, and deliver them to the lower transport unit 27. Each banknote storage bin 29 has a preset denomination of banknotes that it should store.

The banknote collection bin 100 is in the shape of a cuboid that is long in the up and down direction, and a detachable storage bag 101 is set inside. The storage bag 101 is attached with its mouth open to a bag attachment portion 102 provided in the upper end portion of the banknote collection bin 100. That is, the banknote collection bin 100 is provided under a later-described accumulating and strapping unit 104, and is configured so that the storage bag 101, which stores banknote bundles Bu that have been strapped by the accumulating and strapping unit 104, can be attached thereto. Although details are described later, in the storage bag 101, as shown in FIG. 5, bundles Bu of the banknotes (banknote bundles) are stored in a state in which they are each strapped with a clip Cp. To the clip Cp is attached a radio frequency (RF) tag Tc, and in the RF tag Tc is written a bundle identification number for identifying the banknote bundle Bu. The banknote collection bin 100 is provided with a door that opens and closes on a side surface, for example, and is configured so that, by opening the door, the storage bag 101 is able to be easily set inside and the storage bag 101 is able to be easily detached.

Moreover, as shown in FIG. 3B, in the bottom portion of the banknote collection bin 100 is provided a radio frequency identifier (RFID) reader 103 that reads an RF tag Tb attached to the storage bag 101 and the RF tags Tc (FIG. 5) of the clips Cp strapping the banknote bundles Bu stored in the storage bag 101. It will be noted that in the RF tag Tb of the storage bag 101 is written a bag identification number for identifying the storage bag 101.

The lower transport unit 27 has a transport path 70 with four forks, switchers 71, 72, 73, 74 respectively provided in each of the four forks, and an accumulating and strapping unit 104 that accumulates the collected banknotes into bundles and straps the bundles. The transport path 70 is connected to the upper front transport unit 22, the upper rear transport unit 24, the banknote storage bins 29A, 29B, 29C, and the accumulating and strapping unit 104. The lower transport unit 27, as a result of the four switchers 71, 72, 73, 74 being operated in accordance with the control of the banknote control unit 20, switches the banknote transport pathway formed using the transport path 70 to a transport pathway interconnecting the upper front transport unit 22 and either of the banknote storage bins 29A to 29C and the accumulating and strapping unit 104, or a transport pathway interconnecting the upper rear transport unit 24 and either of the banknote storage bins 29A to 29C and the accumulating and strapping unit 104, or a transport pathway interconnecting the upper front transport unit 22 and the upper rear transport unit 24. Additionally, the lower transport unit 27 is configured to transport the banknotes by means of transport rollers along the switched transport pathway.

The accumulating and strapping unit 104 is disposed above the banknote collection bin 100 (i.e., above the storage bag 101) and is configured to accumulate the banknotes that have been transported thereto along the transport path 70, into bundles, strap the bundles with the clips Cp, and drop the banknote bundles into the storage bag 101 below and store them in the storage bag 101.

The bag attachment portion 102 detachably holds the mouth (opening) of the storage bag 101. Furthermore, the bag attachment portion 102 has a mechanism that closes the mouth of the storage bag 101 when the storage bag 101 is detached. Specifically, the bag attachment portion 102 has a mechanism that bonds the mouth of the storage bag 101 using thermal welding or closes and locks the mouth of the storage bag 101 which has a lock mechanism in the mouth portion. Regarding this mechanism an existing mechanism may be used or it may also be omitted from the bag attachment portion 102.

### 1-3. Configuration of Accumulating and Strapping Unit

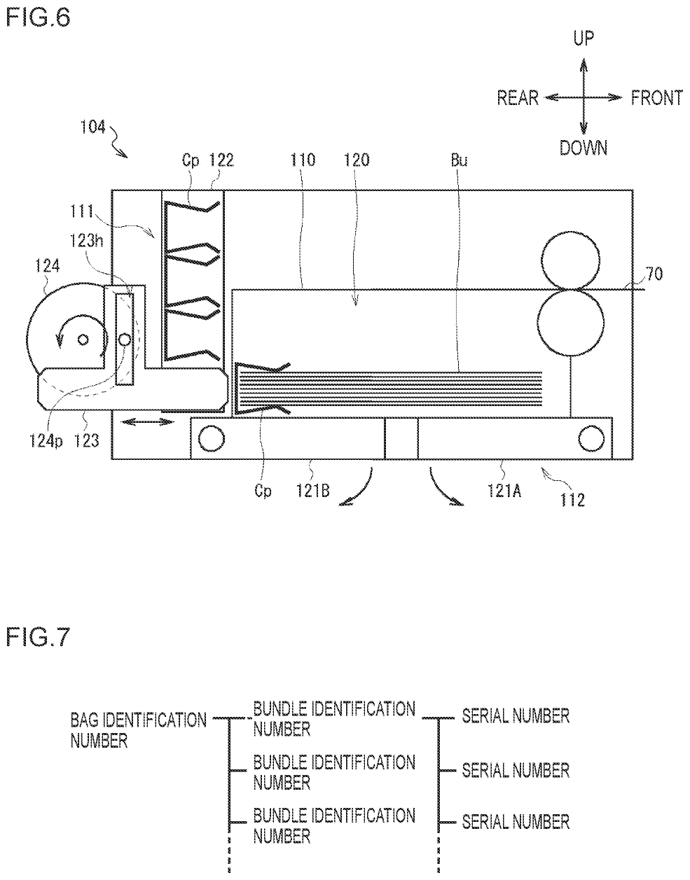

Next, the configuration of the accumulating and strapping unit 104 will be described using FIG. 6. FIG. 6 is a side sectional view of the accumulating and strapping unit 104. The accumulating and strapping unit 104 has a temporary accumulation unit 110 that accumulates the banknotes transported thereto into a bundle, a banknote bundle strapping unit 111 that straps with the clip Cp the banknotes accumulated into a bundle (that is, the banknote bundle Bu) by the temporary accumulation unit 110, and a banknote bundle dropping unit 112 that drops the banknote bundle Bu strapped with the clip Cp from the temporary accumulation unit 110 to the storage bag 101 below (see FIG. 3B).

The temporary accumulation unit 110 has a storage space 120 whose longitudinal and transverse size is substantially the same as the longitudinal and transverse size of the banknotes and whose height is of a size capable of storing from about several tens to about several hundreds of the banknotes. The banknote bundle dropping unit 112 is configured by two tabular members 121A, 121B that form the bottom portion of the storage space 120 and are disposed in a line in the front and rear direction. The temporary accumulation unit 110 is configured to release to the storage space 120 the banknotes that have been transported thereto along the transport path 70 and accumulate them in a bundle on top of the tabular members 121A, 121B of the banknote bundle dropping unit 112. Furthermore, the banknote bundle dropping unit 112 is configured to be able to open, by means of actuators, the two tabular members 121A, 121B downward in the fashion of double doors that open outward from the center. In other words, the banknote bundle dropping unit 112 includes the two tabular members 121A, 121B, which are provided so as to be openable and closable in a position opposing the banknote collection bin 100 and serve as a placement surface on which to accumulate the banknote bundle Bu, and is configured to drop the banknote bundle Bu strapped by the accumulating and strapping unit 104 to the banknote collection bin 100 when the tabular members 121A, 121B change from a closed state to an open state.

The banknote bundle strapping unit 111 has a clip storage compartment 122, a clip push-out member 123, and a gear 124. The clip storage compartment 122 stores the clips Cp by stacking them on top of each other in the vertical direction. The clip storage compartment 122 is disposed in the neighborhood of the back of the storage space 120 and is configured so that the lowermost clip Cp it stores is positioned near the back of the banknote bundle Bu stored in the storage space 120.

The clip push-out member 123 is an inverted T-shaped member configured by a portion that extends in the vertical direction and a portion that extends in the front and rear direction, and the clip push-out member 123 is held so as to be slidable in the front and rear direction by guides. The portion of the clip push-out member 123 that extends in the front and rear direction is disposed in a position opposing the lowermost clip Cp stored in the clip storage compartment 122. In the portion of the clip push-out member 123 that extends in the up and down direction is formed a linear groove 123h that extends in the up and down direction.

As for the gear 124, a drive pin 124p projects from one face thereof orthogonal to a rotational axis parallel to the left and right direction, and the drive pin 124p is disposed so as to be inserted into the groove 123h of the clip push-out member 123.

The banknote bundle strapping unit 111 with this configuration is configured so that when the gear 124 is rotated by an actuator, the clip push-out member 123 coupled via the drive pin 124p is slid in the front and rear direction. Additionally, the banknote bundle strapping unit 111 is configured so that, when the clip push-out member 123 is slid forward from a state in which the clip push-out member 123 is positioned in back of the lowermost clip Cp stored in the clip storage compartment 122, the lowermost clip Cp is pushed out to the storage space 120 so that the banknote bundle Bu stored in the storage space 120 becomes sandwiched and strapped with the clip Cp.

The clip storage compartment 122 is provided with guides that slightly open the clip Cp when the clip Cp is pushed out, so that the banknote bundle Bu can be easily strapped with the slightly opened clip Cp. Furthermore, when the lowermost clip Cp is pushed out forward and the clip push-out member 123 slides rearward, the clips Cp stored in the clip storage compartment 122 move downward.

After the strapping of the banknote bundle Bu by the banknote bundle strapping unit 111 is finished, the accumulating and strapping unit 104 opens the tabular members 121A, 121B of the banknote bundle dropping unit 112 downward by means of actuators to thereby open the bottom portion of the storage space 120 and allow the strapped banknote bundle Bu stored in the storage space 120 to drop into the storage bag 101 below and be stored in the storage bag 101.

It will be noted that the accumulating and strapping unit 104 is configured so that the clip storage compartment 122 is covered by a metal plate, for example, so that the RF tags Tc of the clips Cp stored in the clip storage compartment 122 (i.e., the clips that have not yet dropped to the storage bag 101) are prevented from being read by the RFID reader 103.

### 1-4. Banknote Collection Operation

Next, a banknote collection operation performed by the banknote depositing and dispensing machine 10 will be briefly described. The banknote collection operation is a process that the banknote control unit 20 performs by controlling each part.

The banknote control unit 20 starts the banknote collection operation after it receives from the user via the operation/display unit 6 (FIG. 1) an operation instruction to perform the banknote collection operation or after the state of the banknote depositing and dispensing machine 10 has become a state set as a condition to perform the banknote collection operation. After starting the banknote collection operation, the banknote control unit 20 determines the denomination and number of the banknotes corresponding to the collection amount. Then, the banknote control unit 20 pays out the banknotes one at a time from each banknote storage bin 29 in accordance with the determined denomination and number and transports the banknotes sequentially via the lower transport unit 27 and the upper front transport unit 22 to the classification unit 23.

Here, the banknote control unit 20 reads the serial numbers of the banknotes using the classification unit 23, transports the banknotes sequentially via the upper rear transport unit 24 and the lower transport unit 27 to the accumulating and strapping unit 104, and accumulates the banknotes in a bundle in the accumulating and strapping unit 104. Then, after a predetermined number's worth (e.g., 100) of the banknotes with the same denomination are accumulated in the accumulating and strapping unit 104, the banknote control unit 20 straps with the clip Cp the accumulated bundle of banknotes (i.e., the banknote bundle Bu), allows the strapped bundle to drop to the storage bag 101, and stores the strapped bundle in the storage bag 101.

At this time, the RFID reader 103 (also referred to as an information acquisition unit or a first information acquisition unit) positioned under the storage bag 101 reads the bundle identification number from the RF tag Tc of the clip Cp strapping the banknote bundle Bu stored in the storage bag 101 and sends it to the banknote control unit 20. The banknote control unit 20, as shown in FIG. 7, links (associates) the serial number of each banknote transported to the accumulating and strapping unit 104 (i.e., the serial number of each banknote configuring the banknote bundle Bu stored in the storage bag 101) and the bundle identification number sent from the RFID reader 103, and stores the associated information as storage information in the storage unit 20m.

The RFID reader 103 is also configured to read the bag identification number from the RF tag Tb of the storage bag 101 and send the bag identification number to the banknote control unit 20 when the storage bag 101 has been set in the automated transaction machine 1. Thus, as shown in FIG. 7, the banknote control unit 20 may be configured to further associate the bag identification number to the bundle identification number of the banknote bundle Bu and the serial number of each banknote configuring the banknote bundle Bu, and store the associated information as storage information in the storage unit 20m.

In a case in which there are already multiple banknote bundles Bu stored in the storage bag 101, it is difficult for the RFID reader 103 to recognize which of the banknote bundles Bu stored in the storage bag 101 is the banknote bundle Bu that has been stored at this time. For this reason, in a case in which there are multiple banknote bundles Bu stored in the storage bag 101, the RFID reader 103 reads the bundle identification numbers from the RF tags Tb of all the banknote bundles Bu stored in the storage bag 101 and sends the bundle identification numbers to the banknote control unit 20. The banknote control unit 20 recognizes, as the bundle identification number of the banknote bundle Bu that has been stored in the storage bag 101 at this time, the bundle identification number not yet stored in the storage unit 20m among the multiple bundle identification numbers that have been sent from the RFID reader 103, associates the serial numbers of the banknotes that have been transported to the accumulating and strapping unit 104 at this time (and may also associated the bag identification number) to this bundle identification number, and stores the associated information in the storage unit 20m.

The banknote control unit 20 in this way bundles into the banknote bundle Bu and straps the banknotes paid out from each banknote storage bin 29 and then stores the banknote bundle Bu in the storage bag 101. After the banknote control unit 20 finishes storing the collection amount's worth of the banknote bundle Bu in the storage bag 101, banknote control unit 20 ends the banknote collection operation. Thereafter, for example, a collector pulls out the lower unit 10L of the automated transaction machine 1 forward (or rearward), detaches and collects the storage bag 101 from the banknote collection bin 100.

### 1-5. Summary and Effects

As heretofore described, in the first embodiment, the banknote depositing and dispensing machine 10 of the automated transaction machine 1 includes, as a collection mechanism, the temporary accumulation unit 110 serving as an accumulation unit that accumulates the plural banknotes in a bundle form of banknote bundle Bu, the banknote bundle strapping unit 111 serving as a strapping unit that straps with the clip Cp the banknote bundle Bu accumulated by the temporary accumulation unit 110, and the banknote bundle dropping unit 112 serving as a dropping unit that drops the banknote bundle Bu strapped by the banknote bundle strapping unit 111 from the temporary accumulation unit 110 to the storage bag 101 detachably provided under the temporary accumulation unit 110.

In this way, in the first embodiment, the storage bag 101 may be easily set in the banknote depositing and dispensing machine 10 because the automated transaction machine 1 does not have a mechanism that compresses the lower portion of the storage bag 301 by means of the stage 302 such as shown in FIG. 10. The banknotes do not become disorderly inside the storage bag 101 because the banknotes are stored in a bundled state in the storage bag 101, and totaling work after banknote collection may be easily performed.

In the first embodiment, the automated transaction machine 1 is configured to store in the storage bag 101 the banknote bundle Bu in a state in which the banknote bundle Bu is strapped with the clip Cp. Therefore, it becomes unnecessary to match the longitudinal and transverse size of the storage bag 101 to the longitudinal and transverse size of the banknotes, and, compared with the conventional collection mechanism shown in FIG. 10, a larger size of the storage bag 101 may be used. Because of this, in the banknote depositing and dispensing machine 10 of the first embodiment, the number of banknotes that is able to be collected at one time (i.e., the number of banknotes that is able to be stored in one storage bag 101) may be increased, and the frequency of collection work may be reduced.

Moreover, in the first embodiment, the automated transaction machine 1 is configured to drop in the storage bag 101 the banknote bundle Bu in a state in which the banknote bundle Bu is strapped with the clip Cp Therefore, for example, problems such as one of the banknotes accumulated in the temporary accumulation unit 110 sticking to the temporary accumulation unit 110 due to static electricity or the like and not dropping may also be avoided.

In the first embodiment, the automated transaction machine 1 stores and collects the banknotes in the storage bag 101. Therefore, compared with a case in which, for example, the banknotes are stored in a detachable cassette-type banknote storage bin and the banknotes are collected together with the banknote storage bin, the combined weight of the collected banknotes and the member storing the banknotes (the storage bag 101 or the banknote storage bin) may be reduced, and the burden of collection work may be mitigated. Furthermore, the storage bag 101, in contrast to a cassette-type banknote storage bin, does not have mechanisms for accumulating and paying out the banknotes. Therefore, a situation where a banknote storage bin breaks down during transport and the automated transaction machine 1 being deactivated may be avoided.

In the first embodiment, the automated transaction machine 1 is configured so that the RFID reader 103 serving as a bundle identification information acquisition unit reads, from the RF tag Tc attached to the clip Cp serving as a strapping member that straps the banknote bundle Bu, the bundle identification number serving as bundle identification information for identifying the banknote bundle Bu. The classification unit 23 serving as a media identification information acquisition unit reads, from each banknote configuring the banknote bundle Bu, the serial numbers serving as media identification information for identifying the banknotes. The banknote control unit 20 associates the bundle identification number and the serial numbers and stores the associated information in the storage unit 20m.

Because of this, in the first embodiment, in a case in which, for example, there is a need of searching a banknote having a specific serial number from among the banknotes stored in the storage bag 101, this only requires searching for the banknote from the banknote bundle Bu strapped with the clip Cp having the bundle identification number associated to the serial number of the banknote. Therefore, compared with a case of searching for the banknote from among all the banknotes stored in the storage bag 101, the banknote to be searched may be easily searched for.

Moreover, in the first embodiment, the automated transaction machine 1 is configured so that the RFID reader 103 serving as a bag identification information acquisition unit reads, from the RF tag Tb attached to the storage bag 101, the bag identification number serving as bag identification information for identifying the storage bag 101, and the banknote control unit 20 associates the bundle identification number, the serial numbers, and the bag identification number and stores the associated information in the storage unit 20m.

Because of this, in the first embodiment, for example, which banknote bundle Bu in which storage bag 101 includes a banknote having a specific serial number may be easily identified.

### 2. Second Embodiment

Next, a second embodiment will be described. The second embodiment is an embodiment configured so that information of the banknote bundles Bu that have been collected from the automated transaction machine 1 (hereinafter referred to as collection information) is managed by a management device. Configurations of parts that have been described using FIG. 1 to FIG. 5 are similar to those in the first embodiment, so detailed description thereof will be omitted. Here, the automated transaction machine 1 of the second embodiment will be referred to as an automated transaction machine 1X to differentiate it from that of the first embodiment.

### 2-1. Configuration of Management System

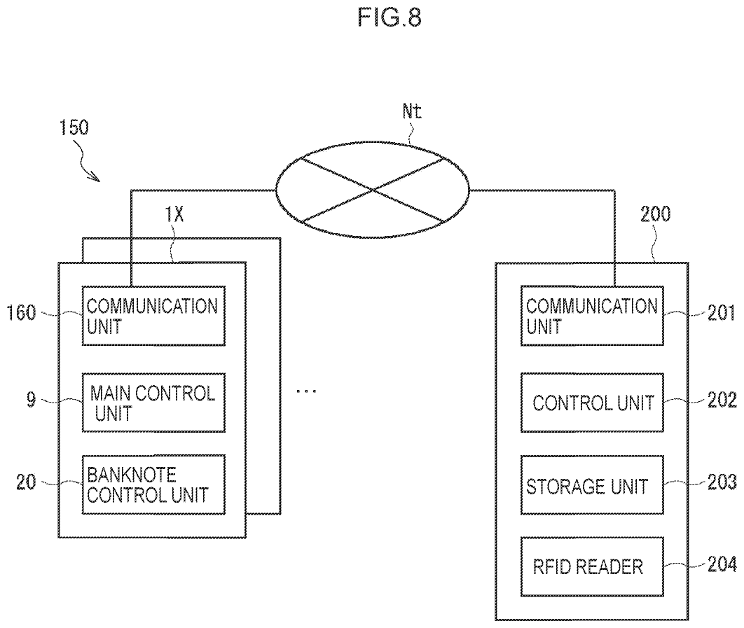

The system configuration of a management system 150 of the second embodiment will be described using FIG. 8. The management system 150 is configured by plural automated transaction machines 1X and a management device 200, and the plural automated transaction machines 1X and the management device 200 are connected via a network Nt such as the internet.

The automated transaction machines 1X each have a configuration where a communication unit 160 for communicating with the management device 200 via the network Nt is added to the automated transaction machine 1 of the first embodiment. Meanwhile, the management device 200 is installed in a collection center, for example, and includes a communication unit 201, a control unit 202, a storage unit 203, and an RFID reader 204 (also referred to as a second information acquisition unit).

The communication unit 201 communicates with the plural automated transaction machines 1X via the network Nt. The control unit 202 controls the entire management device 200 and executes various types of processes. The storage unit 203 stores and manages later-described collection information sent from each automated transaction machine 1X via the network Nt. The RFID reader 204 reads the RF tags Tb of the storage bags 101 that have been carried to the banknote collection center and the RF tags Tc of the clips Cp strapping the banknote bundles Bu stored in the storage bags 101.

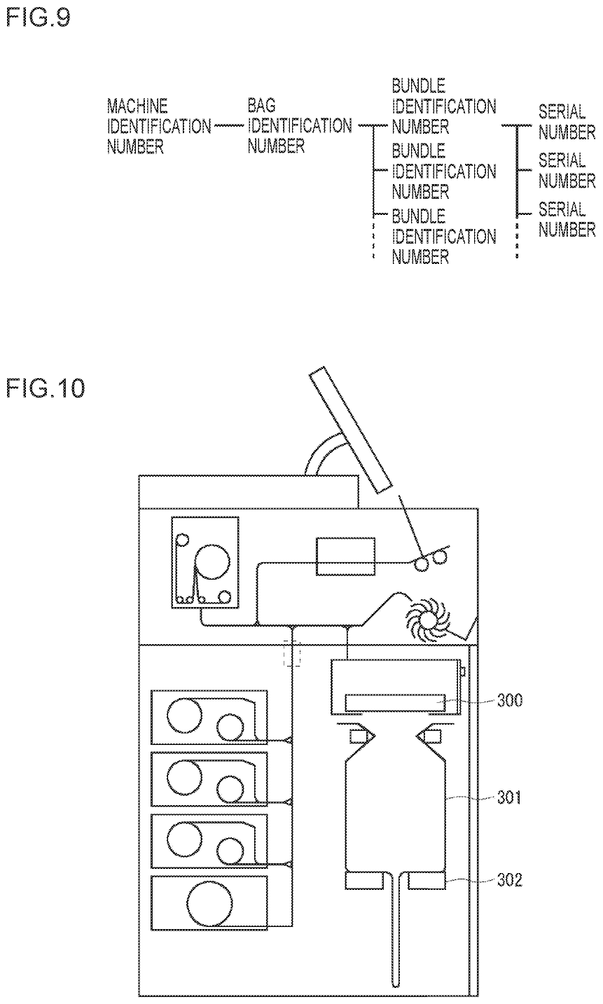

Here, FIG. 9 shows the configuration of the collection information sent from each automated transaction machine 1X to the management device 200. The collection information is information in which a machine identification number for identifying the automated transaction machine 1X, the bag identification number for identifying the storage bag 101 collected from the automated transaction machine 1X, the bundle identification numbers for identifying the banknote bundles Bu stored in the storage bag 101, and the serial numbers of the banknotes configuring the banknote bundles Bu are associated with each other.

Of these information, the bag identification number, the bundle identification numbers, and the serial numbers are delivered from the banknote control unit 20 to the main control unit 9 as storage information relating to the collected storage bag 101. The machine identification number is, for example, stored in the storage unit of the main control unit 9.

After the storage bag 101 is detached from the banknote depositing and dispensing machine 10 after the banknote collection operation performed by the banknote depositing and dispensing machine 10, for example, the main control unit 9 of each automated transaction machine 1X receives the storage information from the banknote control unit 20 at this time, associates the machine identification number to the storage information, and sends the associated information as the collection information by means of the communication unit 160 to the management device 200.

The banknote control unit 20 is, for example, configured to recognize, at the timing when the RF tag Tb of the storage bag 101 is no longer able to be detected by the RFID reader 103, that the storage bag 101 has been detached and notify the main control unit 9 thereof. The configuration is not limited to this and; for example, the collector may insert an individual card into the card insertion/ejection slot 4 of the automated transaction machine 1 at the time of banknote collection work. The main control unit 9 reads from the card an individual management number for identifying the worker performing the collection work. Then, by inputting a collection command to the automated transaction machine 1, the worker may cause the automated transaction machine 1 to perform the banknote collection operation. After the banknote collection operation is finished, the banknote control unit 20 may detect that the storage bag 101 has been replaced and may send the storage information to the main control unit 9. Here, the main control unit 9 may be configured to associate the storage information the machine identification number and the individual management number read from the card inserted into the card insertion/ejection slot 4 (i.e., worker identification information for identifying the worker who performed the collection work), and send these information as the collection information by means of the communication unit 160 to the management device 200.

### 2-2. Operation of Management Device

Next, the operation of the management device 200 will be briefly described. The control unit 202 of the management device 200 receives by means of the communication unit 201 the collection information sent from each automated transaction machine 1X and stores the collection information in the storage unit 203. Because of this, the collection information relating to the storage bag 101 collected from each automated transaction machine 1X is accumulated in the storage unit 203.

Thereafter, for example, the collector carries to the management center the storage bag 101 collected from the automated transaction machine 1X. Here, the storage bag 101 that has been carried by the collector is read by the RFID reader 204 of the management device 200.

At this time, the RFID reader 204 reads the bag identification number from the RF tag Tb of the storage bag 101 and also reads the bundle identification numbers from the RF tags Tc of the clips Cp strapping the banknote bundles Bu stored in the storage bag 101. One bag identification number and one or more bundle identification numbers read by the RFID reader 204 are sent to the control unit 202.

After the control unit 202 acquires the one bag identification number and the one or more bundle identification numbers from the RFID reader 204, the control unit 202 searches the storage unit 203 for collection information having a bag identification number that matches the acquired bag identification number. Then, the control unit 202 determines whether or not the one or more bundle identification numbers included in the collection information obtained from the storage unit 203 by the search all match the one or more bundle identification numbers acquired from the RFID reader 204.

Here, in a case where the one or more bundle identification numbers included in the collection information obtained from the storage unit 203 completely match the one or more bundle identification numbers acquired from the RFID reader 204, this means that the banknote bundles Bu stored in the storage bag 101 represented by the collection information sent from the automated transaction machine 1X actually match the banknote bundles Bu stored in the storage bag 101 that has been carried to the management center.

The control unit 202 then causes, for example, a display unit to display an indication that the storage bag 101 has been properly collected.

By contrast, in a case in which one or more of the bundle identification numbers included in the collection information obtained from the storage unit 203 do not match the one or more of the bundle identification numbers acquired from the RFID reader 204, this means that banknote bundles Bu may be missing from the storage bag 101 that has been carried to the management center.

At this time, the control unit 202 causes, for example, a display unit to display an indication that the data sent from the automated transaction machine 1X are inconsistent with the data read from the storage bag 101.

### 2-3. Summary and Effects

As heretofore described, in the management system 150 of the second embodiment, the automated transaction machine 1X serving as a media handling apparatus includes the communication unit 160 serving as a transmission unit that sends, as the collection information to the management device 200, the bag identification information for identifying the storage bag 101 and the bundle identification information for identifying the banknote bundles Bu serving as media bundles stored in the storage bag 101. Moreover, the management device 200 includes the communication unit 201 serving as a receiving unit that receives the collection information sent from the automated transaction machine 1X, the storage unit 203 that stores the collection information received by the communication unit 201, the RFID reader 204 serving as a bag identification information reading unit that acquires the bag identification number serving as bag identification information from the RF tag Tb of the storage bag 101 and a bundle identification information acquisition unit that acquires the bundle identification numbers serving as bundle identification information from the RF tags Tc of the clips Cp serving as strapping members that strap the banknote bundles Bu stored in the storage bag 101, and the control unit 202 serving as a determination unit that determines whether or not the bag identification number and the bundle identification numbers included in the collection information stored in the storage unit 203 match the bag identification number and the bundle identification numbers acquired by the RFID reader 204.

In this way, in the second embodiment, the management device 200 may recognize, without the storage bag 101 that has been collected actually being opened, whether or not the banknote bundles Bu collected from the automated transaction machine 1 are stored without omission in the storage bag 101 and, therefore, recognition work after banknote collection may be easily performed.

Moreover, in the second embodiment, the automated transaction machine 1X is configured to send, as the collection information to the management device 200, the serial numbers serving as media identification information acquired from each of the plural banknotes configuring the banknote bundles Bu in addition to the bag identification number and the bundle identification number.

Because of this, in the second embodiment, the management device 200 may, for example, easily identify which banknote bundle Bu in which storage bag 101 includes a banknote having a specific serial number. Furthermore, in the second embodiment, the automated transaction machine 1X is configured to add to the collection information and send to the management device 200 the individual management number (worker identification information) of the collector read from the card that the collector inserted into the card insertion/ejection slot 4. Because of this, in the second embodiment, the management device 200 may easily identify the worker who performed the banknote collection work.

### 3. Other Embodiments

### 3-1. Other Embodiment 1

Although in the above first embodiment the automated transaction machine 1 is configured to strap the banknote bundle Bu with the clip Cp, the automated transaction machine 1 is not limited to this and may be configured to strap the banknote bundle Bu using a strapping member other than the clip Cp. For example, the automated transaction machine 1 may strap the banknote bundle Bu using a paper band. In this case, instead of the banknote bundle strapping unit 111 that straps the banknote bundle Bu with the clip Cp, the automated transaction machine 1 may use a banknote bundle strapping unit that straps the banknote bundle Bu using a paper band and may use an existing unit for the banknote bundle strapping unit. Furthermore, as a strapping member other than the clip Cp, the automated transaction machine 1 may use an elastic member such as a rubber band. The same also applies to the second embodiment.

### 3-2. Other Embodiment 2

In the above first embodiment, the RF tag Tc is attached to the strapping member (clip Cp) that straps the banknote bundle Bu, and the bundle identification number is written beforehand in the RF tag Tc. The automated transaction machine 1 is not limited to this; for example, an RFID writer may be provided in the accumulating and strapping unit 104, and the RFID writer may be configured to write a bundle identification number issued by the banknote control unit 20 to the clip Cp when the banknote bundle Bu is to be strapped with the clip Cp. The same also applies to the second embodiment.

Furthermore, the automated transaction machine 1 is not limited to this; for example, a barcode representing the bundle identification information may be applied (printed) beforehand to the strapping member (clip Cp) that straps the banknote bundle Bu. In this case, for example, a barcode reader may be provided in the accumulating and strapping unit 104, and when the banknote bundle Bu is to be strapped with the clip Cp, the barcode reader may read the barcode applied to the clip Cp and notify the banknote control unit 20 thereof. Furthermore, the bundle identification information is not limited to an RF tag or a barcode and may be applied to the strapping member in various forms. The same also applies to the second embodiment.

In the case of strapping the banknote bundle Bu with a paper band as described above, a printing unit may be provided in the banknote bundle strapping unit, and the printing unit may print the bundle identification information on the paper band. The same also applies to the second embodiment. Naturally in the case of applying a barcode to the clip Cp or printing the bundle identification information on the paper band, the bundle identification information becomes unable to be read from the outside of the storage bag 101.

Similarly regarding the bag identification information also, it may be applied in various forms such as a barcode to the storage bag 101. The same also applies to the second embodiment.

### 3-3. Other Embodiment 3

In the above first embodiment, the automated transaction machine 1X is configured to associate and store the bag identification number, the bundle identification numbers, and the serials numbers in the storage unit 20m, but the automated transaction machine 1 is not limited to this and may be configured to associate and store any two of these three pieces of information.

Moreover, in the above second embodiment, the automated transaction machine 1 is configured to associate and store the machine identification number, the bag identification number, the bundle identification numbers, the serial numbers, and the individual management number of the collector in the storage unit 20m, but the automated transaction machine 1 is not limited to this and may be configured to associate and store any two to four of these five pieces of information.

### 3-4. Other Embodiment 4

In each of the above embodiments, the disclosure is applied to the automated transaction machine 1 serving as a media handling apparatus, but it is not limited to this and, for example, may also be applied to media handling apparatus that handle media other than banknotes, such as cash vouchers, gift certificates, admission tickets, and forms. Moreover, in each of the above embodiments, the disclosure the disclosure is applied to the automated transaction machine 1 that handles both deposit transactions and withdrawal transactions, but it is not limited to this and may also be applied to media handling apparatus that handle only deposit transactions.

### 3-5. Other Embodiment 5

The disclosure is not limited to the above embodiments and the other embodiments. That is, the scope of application of the disclosure extends also to embodiments in which some or all or the above other embodiments are arbitrarily combined with the above embodiments and embodiments from which some is omitted.

### INDUSTRIAL APPLICABILITY

The present disclosure is able to be used in various media handling apparatus having a collection mechanism that collects media.

1. A media handling apparatus comprising:
an accumulation unit that is configured to accumulate plural sheets of media in a bundle;
a strapping unit that is configured to strap a media bundle which is the plural sheets of media accumulated by the accumulation unit; and
a storage compartment that is disposed under the strapping unit and to which a storage bag that stores the media bundle strapped by the strapping unit is attached.

2. The media handling apparatus of claim 1, further comprising a dropping unit including tabular members that are provided so as to be openable and closable in a position opposing the storage compartment and that is configured to serve as a placement surface on which to accumulate the media bundle,
wherein the dropping unit is configure to drop the media bundle strapped by the strapping unit to the storage bag when the tabular members transition from a closed state to an open state.

3. The media handling apparatus of claim 1, wherein the strapping unit is configured to strap the media bundle with a strapping member to which bundle identification information for identifying the media bundle has been applied.

4. The media handling apparatus of claim 3, further comprising an information acquisition unit that is configured to acquire the bundle identification information from the strapping member.

5. The media handling apparatus of claim 4, wherein each of the plural sheets of media is applied with a serial number for identifying the medium, and
the media handling apparatus further comprises a classification unit that is configured to acquire the serial numbers from the media.

6. The media handling apparatus of claim 5, further comprising a storage unit that is configured to associate and store the bundle identification information acquired from the strapping member that straps the media bundle and the plural serial numbers acquired from each of the plural sheets of media configuring the media bundle.

7. The media handling apparatus of claim 4, wherein the storage bag is applied with bag identification information for identifying the storage bag, and
the information acquisition unit is configured to acquire the bag identification information from the storage bag.

8. The media handling apparatus of claim 7, wherein the storage unit is configured to store the bundle identification information acquired from the strapping member that straps the media bundle, the plural serial numbers acquired from each of the plural sheets of media configuring the media bundle, and the bag identification information acquired from the storage bag that stores the media bundle, with association to each other.

9. The media handling apparatus of claim 7, further comprising a transmission unit that is configured to send, as collection information to an external device, the bag identification information and the bundle identification information acquired by the information acquisition unit.

10. The media handling apparatus of claim 9, wherein the transmission unit is configured to further send, to the external device, worker identification information for identifying a worker who performed collection work to detach and collect the storage bag from the media handling apparatus.

11. The media handling apparatus of claim 4, wherein
the strapping member is attached with an RF tag in which the bundle identification information is written, and
the information acquisition unit is configured to read the bundle identification information from the RF tag.

12. A management system comprising:
the media handling apparatus of claim 1; and
a management device,
wherein the media handling apparatus further comprises:
a first information reader that is configured to read, from the storage bag, first bag identification information for identifying the storage bag and first bundle identification information for identifying the media bundle stored in the storage bag and
a communication unit that is configured to transmit, to the management device, the first bag identification information and the first bundle identification information acquired by the first information acquisition unit, and
the management device comprises:
a communication unit that is configured to receive the first bag identification information and the first bundle identification information sent from the media handling apparatus,
a storage unit that is configured to store the first bag identification information and the first bundle identification information received by the receiving unit,
a second information reader that is configured to read second bag identification information for identifying the storage bag from the storage bag and second bundle identification information from a strapping member strapping the media bundle stored in the storage bag, and
a processor that is configured to determine whether or not the first bag identification information and the second bag identification information and whether or not the first bundle identification information and the second bundle identification information respectively match.

13. The management system of claim 12, wherein the communication unit of the media handling apparatus is configured to further send, to the management device, worker identification information for identifying a worker who performed collection work to detach and collect the storage bag from the media handling apparatus.
